(19) United States
(12) Patent Application Publication
(10) Pub. No.: US 2019/0186658 A1
(43) Pub. Date: Jun. 20, 2019

(54) NONMETALLIC JOINTS AND METHODS FOR FORMATION AND INSPECTION THEREOF

(71) Applicant: Chevron U.S.A. Inc., San Ramon, CA (US)

(72) Inventors: Robert Ernest Rettew, Houston, TX (US); Samuel J. Mishael, Bellaire, TX (US)

(21) Appl. No.: 15/844,959

(22) Filed: Dec. 18, 2017

(51) Int. Cl. F16L 13/10; F16L 13/11; F16L 9/12; G01B 15/08; G01N 23/083; C09J 175/04; C09J 163/00; C09J 133/08; C09J 11/04; C08K 3/08; C08K 3/16; C08K 3/22; C08K 3/28; C08K 3/30

(52) U.S. Cl. CPC F16L 13/103; C08K 2003/3045; F16L 9/12; G01B 15/08; G01N 23/083; C09J 175/04; C09J 163/00; C09J 133/08; C09J 11/04; C08K 3/08; C08K 3/16; C08K 3/22; C08K 3/28; C08K 3/30; C08K 2003/0856; C08K 2003/2265; C08K 2003/3009; F16L 13/11

(57) ABSTRACT

Disclosed are joints and methods for forming joints of nonmetallic components such as piping components made from a nonmetallic composite material. The components are joined by an adhesive containing an x-ray absorbing additive for providing a contrasting signal in x-ray inspection of the joint. The joints can be nondestructively tested by positioning the joints relative to an x-ray source and an x-ray detector. The joints and the adhesive therein are then exposed to x-ray radiation from the source of x-ray radiation. The x-ray radiation, having passed from the x-ray source to the x-ray detector, is detected over an area and an x-ray image of the x-ray radiation detected is created. The x-ray image is then read to identify defects in the joint.

### FIELD

The present disclosure relates generally to the field of inspecting joints, particularly piping joints in which at least one component is nonmetallic. The present disclosure further relates to the use of adhesives containing radiocontrast additives for x-ray inspection.

### BACKGROUND

Piping systems using nonmetallic pipe and fittings are often specified because of their advantages over metallic piping systems including lower cost, lower maintenance cost, lower weight and higher corrosion resistance. Fiberglass and other nonmetallic materials, joined in a variety of ways, are used in such systems. Currently, such joints cannot be nondestructively inspected to ensure joint integrity before applying pressure to the piping systems. A joint's ability to hold pressure is critical for the operability of the piping system. Determining whether a joint will hold pressure is therefore extremely important. Joint types used include adhesive joints and overwrap joints. Adhesively bonded fiberglass pipes are known to become unbonded at a joint and lose integrity; therefore, an overwrap is sometimes applied to an adhesive fiberglass joint, increasing costs. Both types of joints can be inspected to varying degrees using acoustic, microwave and x-ray techniques, but none of these techniques are sufficiently powerful or accurate to provide a strong and reliable inspection method for current nonmetallic piping systems.

There exists a need for a method of nondestructive inspection of nonmetallic piping joints.

### SUMMARY

In one aspect, the disclosure relates to a joint of two components positioned in a desired three-dimensional position relative to each other and defining an adhesive space there between. At least one of the two components is made from a nonmetallic composite material. The two components are joined by an adhesive at least partially filling the adhesive space. The adhesive contains an x-ray absorbing additive for providing a contrasting signal in subsequent x-ray inspection of the joint.

In another aspect, the disclosure relates to a method for forming a joint including positioning the two components in the desired three-dimensional position relative to each other such that an adhesive space is defined between the two components. At least one of the two components is made from a nonmetallic composite material. The two components are joined by at least partially filling the adhesive space with an adhesive containing an x-ray absorbing additive.

In yet another aspect, the disclosure relates to a method for inspecting joints. The joint described above is positioned relative to a source of x-ray radiation such that the source of x-ray radiation is positioned a first distance from one of the two components in contact with the adhesive. An x-ray detector is positioned a second distance from the other of the two components in contact with the adhesive. The adhesive is irradiated with x-ray radiation from the source of x-ray radiation. The x-ray radiation, having passed from the source of x-ray radiation to the x-ray detector, is detected over an area and an x-ray image of the x-ray radiation detected is created. The x-ray image is then read to identify defects in the joint.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 illustrates a joint and a method for inspecting the joint according to exemplary embodiments.

FIG. 2 illustrates another joint and a method for inspecting the joint according to exemplary embodiments.

### DETAILED DESCRIPTION

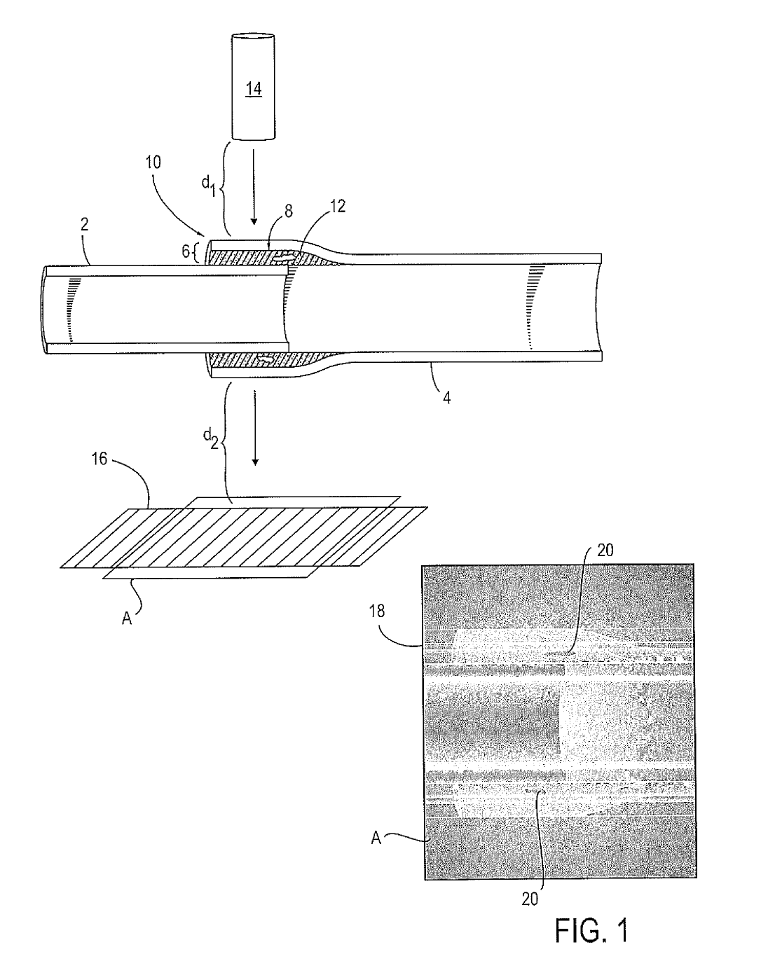

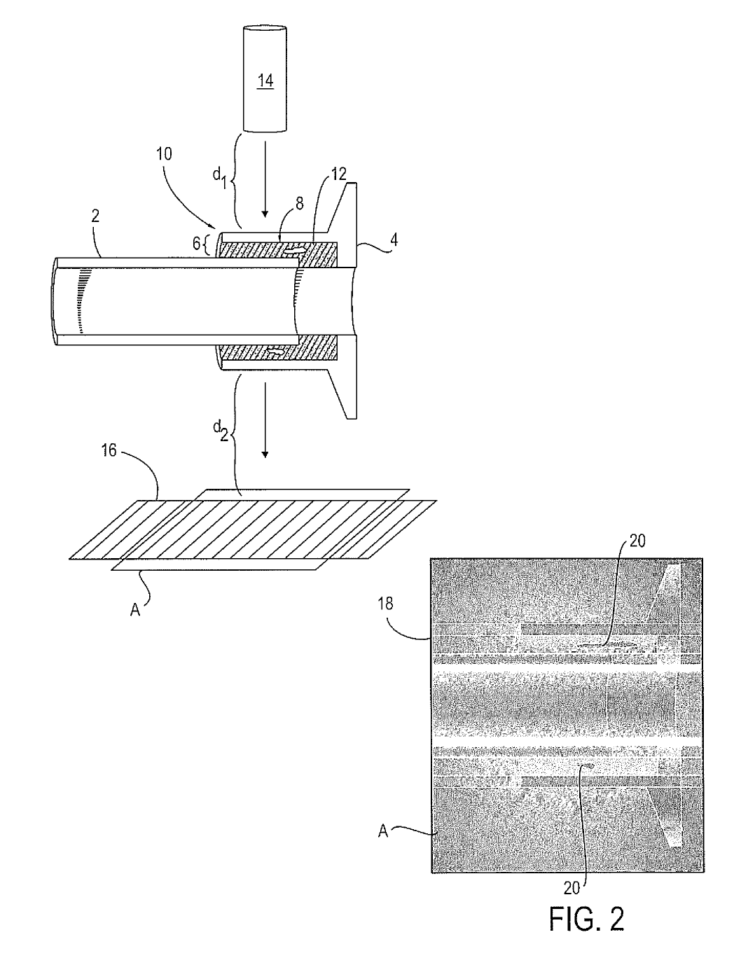

In one embodiment, referring to FIG. 1, a joint 10 and a method for making the joint 10 connecting two components 2 and 4 are provided. The two components 2 and 4 are positioned in a desired three-dimensional position relative to each other. The space between the two components 2 and 4 defines a three-dimensional adhesive space 6. At least one of the two components 2 and 4 is made from a nonmetallic composite material. In one embodiment, the joint 10 is a piping joint by which is meant that at least one of the components is a section of pipe. The joint 10 can be a taper type joint, a bell and spigot type joint, a socket type joint, an adhesive type joint, a male/female type joint, and the like. In the embodiment shown in FIG. 1, the joint connects two sections of pipe 2 and 4. In one embodiment, referring to FIG. 2, one of the two components is a pipe 2 and the other component is a flange 4. It is noted that, as used in this specification, “component 4” can refer to either a section of pipe or a flange. The joint 10 may optionally include an O-ring, gasket or other component, not shown, as would be apparent to one of ordinary skill in the art. Assembly of the joint requires a suitably clean and environmentally controlled, i.e., dry and not overly cold, setting to ensure proper adhesion.

In one embodiment, the nonmetallic composite material of component 2 and/or 4 is a polymer matrix having a fiber reinforcement within the polymer matrix. In one embodiment, at least one of the two components 2 and/or 4 is a fiberglass pipe. The fiberglass contains glass fibers in a matrix of resin. Many types of fiber can be used. The resin can be an epoxy, such as bisphenol, novolac, aliphatic, or other similar polymer or resin.

Further examples of suitable nonmetallic materials for use in the components 2 and/or 4 include polyvinyl chloride, high density polyethylene, polypropylene and polyvinylidene fluoride, and composites of these materials when combined with fiber reinforcement.

In one embodiment, an adhesive material 8 is applied by any convenient means to component 2 and/or 4 at a desired location and the two components 2 and 4 are pressed together such that an adhesive bond is formed between the components 2 and 4. The adhesive material 8 at least partially fills the adhesive space 6 and contacts components 2 and 4, thereby adhesively joining the two components 2 and 4. Examples of suitable materials for the adhesive 8 include epoxy, acrylic, polyurethane and combinations thereof. Optionally, the adhesive may further include a liquid hardener to be mixed into the adhesive 8 on-site at the time the joint 10 is assembled. The adhesive 8 bond may further require curing depending on the specific adhesive material used as would be understood to one skilled in the art.

The adhesive 8 contains an x-ray absorbing additive 12. The concentrations of additive 12 may vary from 0.01% to 15% measured by mass, and may involve multiple or only a single additive. The x-ray absorbing additive 12 provides a contrasting signal in subsequent x-ray inspection of the joint 10. In one embodiment, the x-ray absorbing additive 12 can be any material having a suitably high density and high atomic number to be effective at stopping x-rays and gamma rays. Examples of suitable x-ray absorbing additives include barium sulfate, sodium iodide, potassium iodide, bismuth oxide, bismuth sulfide, bismuth iodide, bismuth nitrate, iron oxide, iron powder and combinations thereof.

The x-ray absorbing additive 12 can be incorporated into the adhesive 8 in any convenient manner. For example, the additive 12 can be added in powder or viscous liquid form via mixing to the adhesive 8 in liquid form at the time the joint 10 is assembled. Automatic, manual or mechanized mixing may be used to disperse the additive 12 within the adhesive 8.

In one embodiment, referring again to to FIGS. 1 and 2, a method for inspecting a joint such as joint 10 described above is provided. A source of x-ray radiation 14, in the form of an analog or digital portable device of the type commonly used for pipe inspection tasks, also referred to as an x-ray source 14, is positioned a first distance d₁ from one of the two components 2 and/or 4, the two components being in contact with the adhesive 8. In one embodiment, the source of x-ray radiation 14 is an x-ray emitting tube, gun, or other device containing a radioactive isotope such as Ir-192, Co-60, or other common source used in industry. The device is shielded and capable of opening to emit x-ray light towards the part to be inspected. Exemplar types of x-ray source are commercially available from multiple companies including contracting services such as TEAM Industrial Services (Alvin, Tex.), ROSEN Group (Houston, Tex.) and Oceaneering International, Inc. (Houston, Tex.).

In another embodiment, the x-ray source 14 may be an electric x-ray generator that generates x-rays electrically through use of a metallic source such as Cu or other transition metal. These sources are commercially available and provide similar x-rays or gamma rays to the embodiment described above, but are generated electrically rather than radioactively.

The x-ray source 14 has an energy level exceeding the absorption energy of the x-ray absorbing additive 12. Commonly used x-ray sources in industrial applications range in energy from 150 to 370 keV. Therefore, as an example, in one environment, suitable x-ray absorbing additives 12 have an absorption energy of less than 150 keV. Exemplary absorption energies include: 7 keV for iron, 37 keV for barium, 33 keV for iodine, and 90 keV for bismuth. The quantity and identity of absorbing additive 12 are selected so that the absorption length of x-ray source 14 is comparable to the dimensions of the material to be inspected. This allows for measurable differences in the x-ray signal. The range of absorption lengths may vary from 0.1 mm to 10 cm.

An x-ray detector 16, of a type commonly used in the pipe and pipeline industries in common practice, is positioned a second distance d₂ from the other of the two components 2 and/or 4. The x-ray detector 16 can be either a digital or film-based x-ray imaging device. Exemplar types of detector are commercially available from multiple companies including contracting services such as TEAM Industrial Services, ROSEN Group and Oceaneering International, Inc. The adhesive 8 can then be irradiated with x-ray radiation from the source of x-ray radiation 14. The time period of x-ray radiation will be specifically controlled to achieve the measurement. The x-ray radiation, having passed from the source of x-ray radiation 14 to the x-ray detector 16, can be detected over an area A and an x-ray image 18 of the x-ray radiation detected can be created. The x-ray image 18 can be created by either a chemical or a digital process.

The x-ray image 18 can then be read to identify defects 20 (if any) in the joint. Defects 20 can be identified by any indication that the amount of the x-ray absorbing additive 12 in the adhesive space 6 between the two components 2 and 4 is insufficient, excessive or nonuniformly distributed. Defects 20 can also be identified by any indication that the x-ray absorbing additive 12 is misplaced in the adhesive space 6 between the two components 2 and 4.

Joints made and inspected by the methods herein can be advantageously used in nonmetallic piping systems including, but not limited to, piping systems in refining, offshore seawater and firewater applications. By use of embodiments disclosed herein, piping can be inspected nondestructively prior to pressurization. This allows the operator to avoid the risk of failure during pressurization, and associated safety hazards and schedule delays.

It should be noted that only the components relevant to the disclosure are shown in the figures, and that many other components normally part of piping systems and x-ray inspection systems are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

This written description uses examples to disclose the invention, including the best mode, and to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference. From the above description, those skilled in the art will perceive improvements, changes and modifications, which are intended to be covered by the appended claims.

What is claimed is:

1. A joint of two components, comprising:
a. two components positioned in a desired three-dimensional position relative to each other and defining an adhesive space between the two components, wherein at least one of the two components comprises a nonmetallic composite material; and
b. an adhesive at least partially filling the adhesive space for joining the two components;
wherein the adhesive contains an x-ray absorbing additive for providing a contrasting signal in subsequent x-ray inspection of the joint.

2. The joint of claim 1, wherein the nonmetallic composite material comprises a polymer matrix and a fiber reinforcement within the polymer matrix.

3. The joint of claim 1, wherein the adhesive is selected from the group consisting of epoxy, acrylic, polyurethane and combinations thereof.

4. The joint of claim 1, wherein the x-ray absorbing additive has an absorption energy of less than 150 keV.

5. The joint of claim 1, wherein the x-ray absorbing additive is selected from the group consisting of barium sulfate, sodium iodide, potassium iodide, bismuth oxide, bismuth sulfide, bismuth iodide, bismuth nitrate, iron oxide, iron powder and combinations thereof.

6. The joint of claim 1, wherein the joint is a piping joint and at least one of the two components is a fiberglass pipe.

7. The joint of claim 1, wherein one of the two components is a fiberglass pipe and the other of the two components is a flange.

8. A method for forming joints, comprising:
a. positioning two components in a desired three-dimensional position relative to each other such that an adhesive space is defined between the two components, wherein at least one of the two components comprises a nonmetallic composite material; and
b. joining the two components by at least partially filling the adhesive space with an adhesive containing an x-ray absorbing additive.

9. The method of claim 8, wherein the nonmetallic composite material comprises a polymer matrix and a fiber reinforcement within the polymer matrix.

10. The method of claim 8, wherein the adhesive is selected from the group consisting of epoxy, acrylic, polyurethane and combinations thereof.

11. The method of claim 8, wherein the x-ray absorbing additive has an absorption energy of less than 150 keV.

12. The method of claim 8, wherein the x-ray absorbing additive is selected from the group consisting of barium sulfate, sodium iodide, potassium iodide, bismuth oxide, bismuth sulfide, bismuth iodide, bismuth nitrate, iron oxide, iron powder and combinations thereof.

13. The method of claim 8, wherein the joint is a piping joint and at least one of the two components is a fiberglass pipe.

14. The method of claim 8, wherein one of the two components is a fiberglass pipe and the other of the two components is a flange.

15. A method for inspecting a joint, comprising:
a. providing a joint according to claim 1;
b. positioning a source of x-ray radiation a first distance from one of the two components in contact with the adhesive;
c. positioning an x-ray detector a second distance from the other of the two components in contact with the adhesive;
d. exposing the joint to x-ray radiation from the source of x-ray radiation such that the adhesive is exposed to x-ray radiation from the source of x-ray radiation;
e. detecting x-ray radiation having passed from the source of x-ray radiation and through the adhesive to the x-ray detector over an area;
f. creating an x-ray image of the x-ray radiation detected; and
g. reading the x-ray image to identify defects if any in the joint.

16. The method of claim 15, wherein the source of x-ray radiation comprises an x-ray emitting tube containing a radioactive isotope or an electric x-ray generator.

17. The method of claim 15, wherein the x-ray detector comprises a digital or film-based x-ray imaging device.

18. The method of claim 15, wherein the x-ray image is created by a chemical or digital process.

19. The method of claim 15, wherein the defects in the joint are identified by an indication that the amount of the x-ray absorbing additive in the adhesive space between the two components is insufficient; excessive; nonuniformly distributed; and/or misplaced in the adhesive space between the two components.
